(19) United States
(12) Patent Application Publication
(10) Pub. No.: US 2026/0111498 A1
(43) Pub. Date: Apr. 23, 2026

(54) TRAINING ARTIFICIAL INTELLIGENCE (AI) ENGINES FOR CUSTOM OBJECT DESCRIPTION GENERATION

(71) Applicant: TrustClarity, Inc., Chicago, IL (US)

(72) Inventor: Haran Sujeevan Jeganathan, Chicago, IL (US)

(21) Appl. No.: 19/424,519

(22) Filed: Dec. 18, 2025

Related U.S. Application Data
(63) Continuation-in-part of application No. 17/868,555, filed on Jul. 19, 2022, now abandoned.
(60) Provisional application No. 63/225,240, filed on Jul. 23, 2021.

(51) Int. Cl. G06F 16/951; G06F 16/958; G06N 20/00

(52) U.S. Cl. CPC G06F 16/951; G06F 16/958; G06N 20/00

(57) ABSTRACT

An artificial intelligence (AI) engine assists in the creation of product descriptions. For example, a system that includes the AI engine receives raw data including a description of a product and generates a search query based on the raw data to search the internet for possible product descriptions that satisfy the query. The system can parse the product descriptions into categories of content that map to sections of a template and creating the custom product description based on a selection and combination of the categories of content of the product descriptions matched to sections of the template. An AI engine is trained based on the selection and combination of the categories of content and ranks the content based on a frequency of being included in custom product descriptions such that the system can later recommend content in accordance with the ranking for creating a custom product description.

### CROSS-REFERENCE TO RELATED APPLICATIONS

This application is a continuation in part of U.S. Patent Application No. 17/868,555 filed July 19, 2022, which claims priority to U.S. Patent Application No. 63/225,240 filed July 23, 2021, the content of which is hereby incorporated in its entirety.

### TECHNICAL FIELD

The disclosed teachings relate to techniques for artificial intelligence (AI) agents to assist in creating custom object artifacts, such as custom product descriptions for electronic commerce.

### BACKGROUND

The market for global electronic components was approximately $370 billion in 2019. Large companies regularly purchase products in bulk and with long lead times. This is partially due to manufacturers requiring a large minimum order number for products and due to the time it takes for manufacturing. As such, it is not uncommon for those companies to have excess inventory of products. In certain industries, such as cable and telecommunications, companies order excess products valuing between $500000 to $300 million. In another example, repair centers have excess purchases valued between $200000 and $100 million per company.

Specifically, the excess ordering is caused due to complexity of the product marketplace, long lead times, high minimum order quantities, and inaccurate forecasting. In addition to the extra money spent, the excess products are often discarded at an alarming rate. For instance, 2 billion tons of e-waste are produced globally every year with only 13% being recycled and 5% composted.

The resale of excess product normally goes through brokers who manually evaluate the product to prepare a product description. In another example, the original buyers use their own product information to create descriptions for resale, which oftentimes results in incomplete or incorrect descriptions. A compelling product description provides customers with details around features, problems it solves and other benefits to help generate a sale. That is, the purpose of a product description is to supply customers with important information about the features and benefits of the product so that customers will be compelled to buy.

### BRIEF DESCRIPTION OF THE DRAWINGS

FIG. 1 is a block diagram that illustrates a system including an artificial intelligence (AI) engine that assists in the creation of product descriptions, in accordance with some implementations of the present technology.

FIG. 2 is a flowchart that illustrates a process for AI engine-assisted creation of product descriptions, in accordance with some implementations of the present technology.

FIG. 3 is a block diagram that illustrates an example of a processing system in which at least some operations described herein can be implemented.

FIG. 4 is a flowchart that illustrates a process for training an AI agent to assist in the creation of a custom object artifact, in accordance with some implementations of the present technology.

FIG. 5 is a block diagram of an example transformer, in accordance with some implementations of the present technology.

FIG. 6 is a block diagram that illustrates an example of an AI system in which at least some operations described herein can be implemented.

FIG. 7 is a block diagram that illustrates an example of a computer system in which at least some operations described herein can be implemented.

### DETAILED DESCRIPTION

The disclosed technology relates to an artificial intelligence (AI) engine, which can be or include an AI agent, for creating a custom product description based on raw product data. In one example, raw product data is pre-processed to build an expanded search query that is used to search the internet (or another corpus) for similar product descriptions. The search results can be parsed into categories that define sections of a template for building the custom product description. The content in the sections can be ranked and/or recommended for populating the template. For example, an AI agent/AI engine can recommend one or more categories of content for population based on the ranking of those categories.

A user or system can mix-and-match content of the sections of the template. The combination and content of data used to populate the template are input as training data for the AI engine to rank/recommend in the future. The user can also directly edit the content that populates the template. The edits are further training data for the AI engine, which can learn to edit content used to populate templates in the future. The resulting custom product description can then be posted online as an offering of the product, which would be ranked higher by a search engine. Thus, the AI engine creates consumer friendly descriptions based on raw product data and improves the likelihood that other users will find the product description when searching online. Doing so can reduce inventories of excess products.

Specifically, companies regularly order products in bulk from manufacturers months in advance, based on a forecast because manufacturers require long lead times. Additionally, companies are generally forced to order in bulk because many manufacturers require a large minimum order number. As such, companies are often left with excess products. These excess products can amount to millions of dollars of loss.

To mitigate the loss, some companies rely on a resale market. Two resale markets include broker-dealers and online resale websites. Broker-dealers are third-party sales companies that routinely contact companies to offer to resell their excess products in exchange for a portion of the sale price. After an agreement is reached, the broker-dealers then find a buyer with matching interests by using similar methods and negotiate the exchange of the excess products. The buyer makes the purchase based on trusting all the parties involved. The trust can be developed based on prior interactions, the corporation involved, or proof of provenance. In one example, Comcast is selling an excess inventory of products. A buyer, due to a preexisting relationship with Comcast and trusting that a large corporation would see authenticate products, could buy the excess products due to the additional comfort and trust. Moreover, the buyer would trust the broker-dealer would perform reasonable checks to verify the authenticity of the products, based again, on prior interactions or positive history of the broker-dealer.

Another option is using online resale websites such as eBay or Amazon. On these websites, companies or broker-dealers can post a product description (e.g., a product listing) for the excess products. The description can include pictures of the products, specifications of the products, the current location, and ratings of the seller. The information regarding the products can be inputted by the seller and the ratings can be based on reviews by previous customers. For example, a particular seller can have a four star review out of five stars. The online marketplace can, for example, determine the star rating based on an average of stars given by the past buyers.

This original buyer-to-reseller to resale-buyer eco-system causes many issues. First, the minimum requirements of manufacturers force companies to purchase more products than they need. For example, a corporation with a history of selling 900 widgets may still be forced to order 1,000 widgets because that is the minimum order number from the manufacturer of the widget. As a result, the company must rely on the resale market to recoup at least some of the losses. In another example, a company may forecast a need for 5,000 widgets, which could turn out to be overly optimistic when unexpected economic conditions occur. Again, the company must rely on the resale market to recoup losses.

Second, by having to order the minimum number of products, companies create unnecessary waste. Further to the example above, the company can have up to 100 excess widgets. In the resale market, an additional 80 widgets may sell. Thus, even after mitigating loss, the corporation is left with 20 excess widgets. The excess inventory is then often discarded, if not used within a reasonable amount of time due to inventory holding costs, shelf space, and accounting benefits.

Third, long lead times and large minimum order requirements push smaller companies out of the market. For example, large companies with a large credit line, large profit margins, and lengthy histories in the market, are more likely to be able to make large orders with a reasonably reliable forecast and can financially bear the risk of being wrong. On the other hand, smaller or start-up companies with small or no profit margins, and less reliable forecasting methods are less likely to be able to make such orders. Thus, these companies may struggle to find original products and may have to rely exclusively on the resale market. This causes further issues because smaller startups will struggle to be one of the first in the market because the larger companies will likely sell their excess products after the market has been saturated. Also, in contrast to larger, profitable companies, unintentional or excess inventory orders can have a material and sometime catastrophic impact to small business if not handled properly.

Fourth, the resale market can be easily exploited. Namely, resellers can sell counterfeit or inferior products to the buyer. For example, a reseller can list on an online marketplace an offer to resell a scratch resistant encasing for a cable modem box manufactured for Comcast. The reseller can specify in the listing that the box is made of scratch resistance material and the reseller may have positive reviews. Based on this information, a buyer may feel that the risk of fraud is low and place the order. However, the buyer is not presented concrete proof that the box has the qualities listed in the offer. In other words, the buyer must perform a risk analysis based on the product description that is posted to eventually get to a point where the buyer is comfortable assuming the risk. However, every aspect of the product description can be manipulated. For example, the reseller may have posted the positive reviews themselves or posted false information regarding the product. That is, the box may not be scratch proof or manufactured for Comcast; it could instead be a counterfeit box.

Oftentimes, the problem with resale sites is that product descriptions are incomplete or inaccurate. The reseller must provide images and text descriptions of a product, which is oftentimes challenging because the original seller or buyer may not have all product information available. As a result, the product descriptions are incomplete and/or erroneous. Moreover, potential buyers may forego buying products with incomplete or inadequate product descriptions or buy the wrong products.

The AI engine-enabled technology introduced here can create a custom object artifact, which can be a custom description for a product, based on raw product data. In one example, raw product data is pre-processed to build an expanded search query that is used to search the internet for similar product descriptions. The search results are parsed into categories that define sections of a template for building the custom product description. The content in the sections is ranked and/or recommended for populating the template. The user can then mix-and-match content of the sections of the template. The combination and content of data used to populate the template are input as training data for the AI engine to rank/recommend in the future. A user can also directly edit the content that populates the template. The edits are further training data for the AI engine, which can learn to edit content used to populate templates in the future. The resulting custom product description can then be posted online as an offering of the product, which would be ranked higher by a search engine because it is information rich. Thus, the AI engine creates consumer friendly descriptions based on raw product data and improves the likelihood that other users will find the product description when searching online.

### SYSTEM FOR AI ENGINE-ASSISTED CREATION OF PRODUCT DESCRIPTIONS

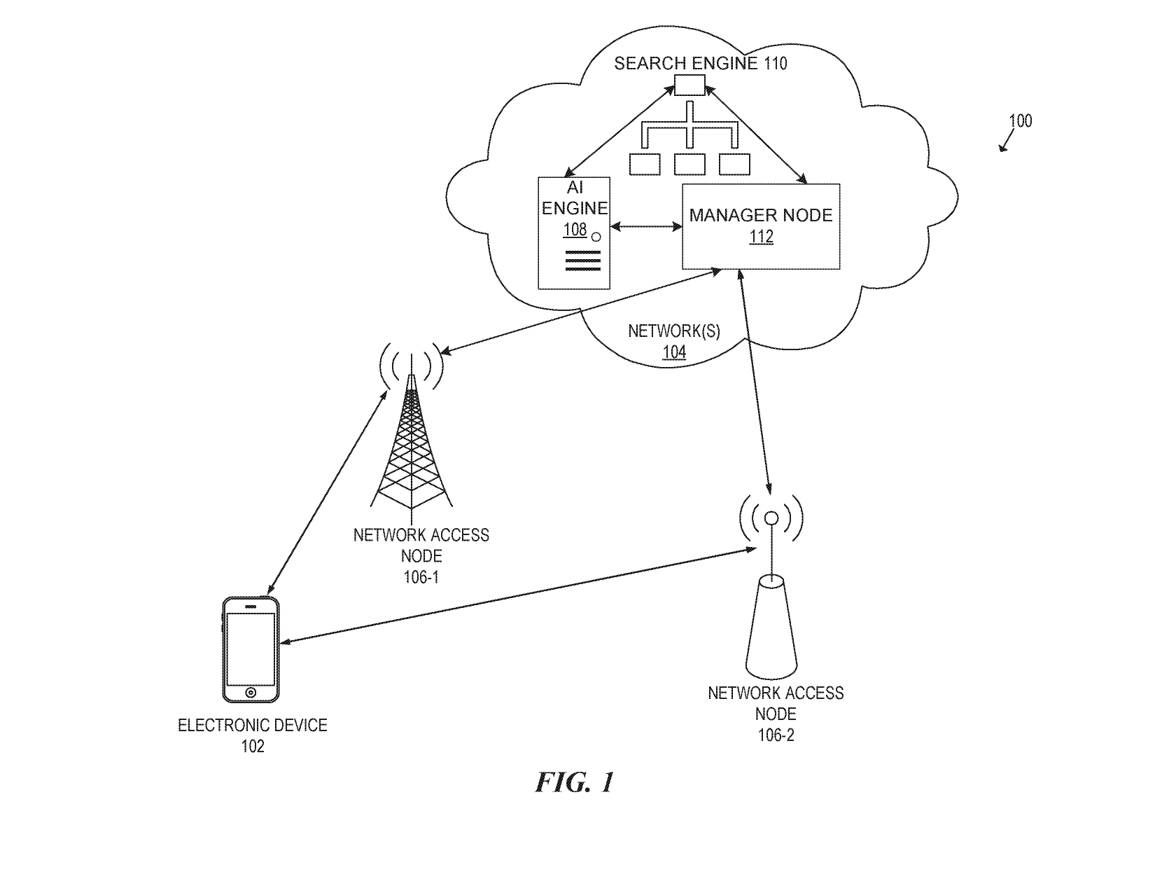

FIG. 1 is a block diagram that illustrates a system including an AI engine that assists creation of product descriptions, in accordance with some implementations of the present technology. The system 100 includes an electronic device 102 that is communicatively coupled to one or more networks 104 via network access nodes 106-1 and 106-2 (referred to collectively as network access nodes 106). The electronic device 102 is any type of electronic device that can communicate wirelessly with a network node and/or with another electronic device in a cellular, computer, and/or mobile communications system. Examples of the electronic device 102 include smartphones (e.g., APPLE IPHONE, SAMSUNG GALAXY), tablet computers (e.g., APPLE IPAD, SAMSUNG NOTE, AMAZON FIRE, MICROSOFT SURFACE), personal computers, enterprise servers, wireless devices capable of machine-to-machine (M2M) communication, wearable electronic devices, movable Internet of Things devices (IoT devices), and any other handheld device that is capable of accessing the network(s) 104. Although only one electronic device 102 is illustrated in FIG. 1, the disclosed embodiments can include any number of electronic devices.

The electronic device 102 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustical, or other forms of propagated signals, such as carrier waves or infrared signals).

The electronic device 102 can include hardware such as one or more processors coupled to sensors and a non-transitory machine-readable media to store code and/or sensor data, user input/output (I/O) devices (e.g., a keyboard, a touchscreen, and/or a display), and network connections (e.g., an antenna) to transmit code and/or data using propagating signals. The coupling of the processor(s) and other components is typically through one or more busses and bridges (also referred to as bus controllers). Thus, a non-transitory machine-readable medium of a given electronic device typically stores instructions for execution on a processor(s) of that electronic device. One or more parts of an embodiment of the present disclosure can be implemented using different combinations of software, firmware, and/or hardware.

The network access nodes 106 can be any type of radio network node that can communicate with a wireless device (e.g., electronic device 102) and/or with another network node. The network access nodes 106 can be a network device or apparatus. Examples of network access nodes include a base station (e.g., network access node 106-1), an access point (e.g., network access node 106-2), or any other type of network node such as a network controller, radio network controller (RNC), base station controller (BSC), a relay, transmission points, and the like.

The system 100 depicts different types of network access nodes 106 to illustrate that the electronic device 102 can access different types of networks through different types of network access nodes. For example, a base station (e.g., the network access node 106-1) can provide access to a cellular telecommunications system of the network(s) 104. An access point (e.g., the network access node 106-2) is a transceiver that provides access to a computer system of the network(s) 104. The network(s) 104 can include any combination of private, public, wired, or wireless systems such as a cellular network, a computer network, the Internet, and the like. Any data communicated over the network(s) 104 can be encrypted or unencrypted at various locations or along different portions of the networks. Examples of wireless systems include Wideband Code Division Multiple Access (WCDMA), High Speed Packet Access (HSPA), Wi-Fi, Wireless Local Area Network (WLAN), and Global System for Mobile Communications (GSM), GSM Enhanced Data Rates for Global Evolution (EDGE) Radio Access Network (GERAN), 4G or 5G wireless wide area networks (WWAN), and other systems that can also benefit from exploiting the scope of this disclosure.

A "model," as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the model can be a neural network with multiple input nodes that receive input data. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, ("the output layer") one or more nodes can produce a value classifying the input that, once the model is trained, can be used as to generate product data. In some implementations, such neural networks, known as deep neural networks, can have multiple layers of intermediate nodes with different configurations, can be a combination of models that receive different parts of the input and/or input from other parts of the deep neural network, or are convolutions - partially using output from previous iterations of applying the model as further input to produce results for the current input.

A machine learning (ML) model or algorithm can build a model based on sample data, known as training data, in order to make predictions or decisions without being explicitly programmed to do so. ML models can be trained with supervised learning, where the training data includes certain data as input and a desired output. A representation of product descriptions can be provided to the model. Output from the model can be compared to the desired output for product descriptions and, based on the comparison, the model can be modified, such as by changing weights between nodes of the neural network or parameters of the functions used at each node in the neural network (e.g., applying a loss function). After applying each of the product descriptions in the training data and modifying the model in this manner, the model can be trained to evaluate new product descriptions.

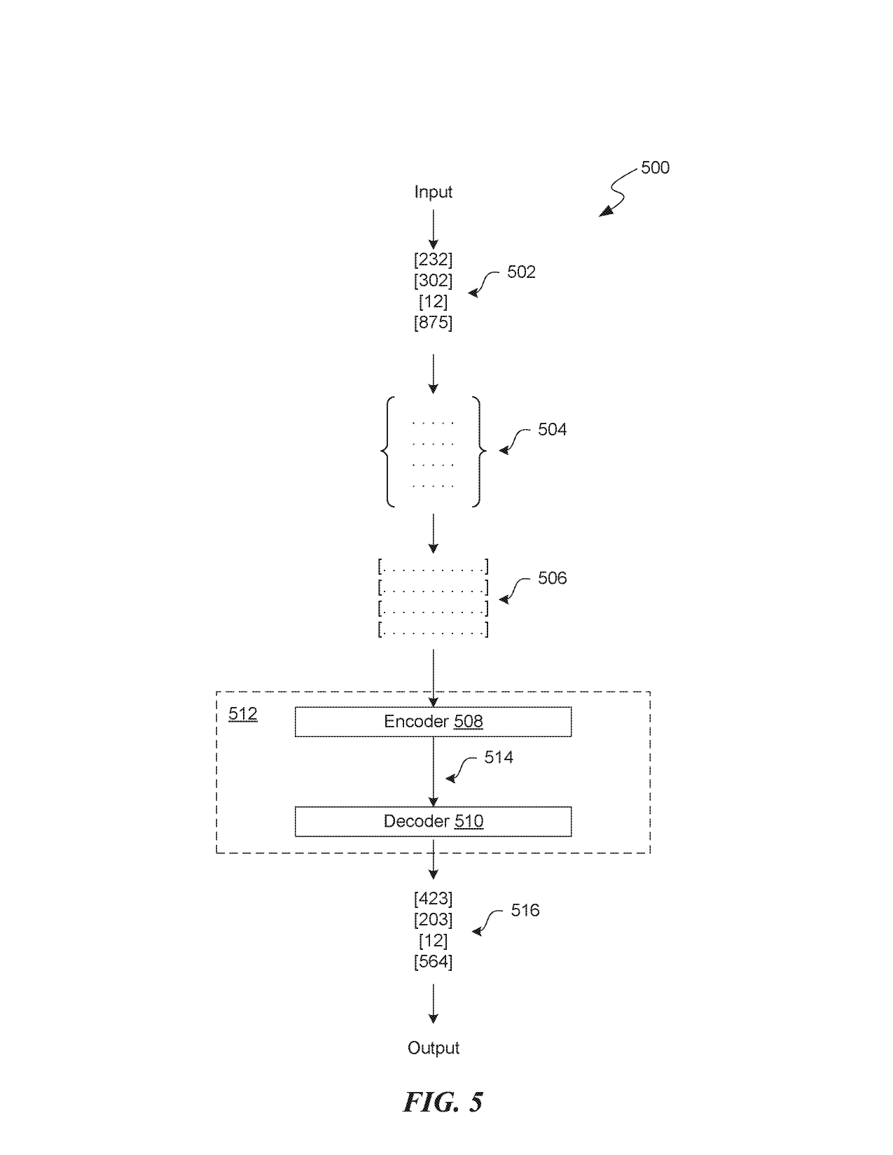

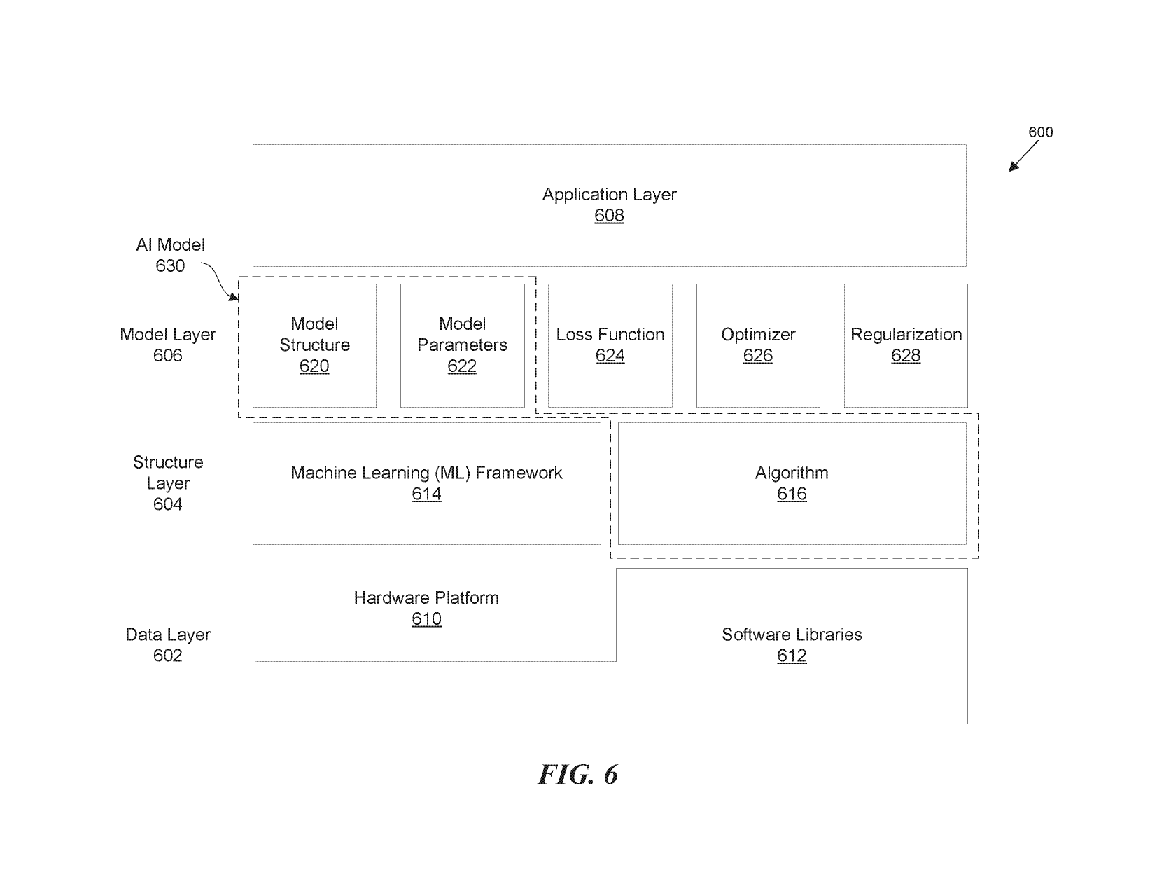

The system 100 includes an AI engine 108 that assists in the creation of product descriptions. The AI engine 108 can include one or more components of the example transformer 512 described in relation to FIG. 5 below and/or the AI system 600 described in relation to FIG. 6 below. Additionally or alternatively, the AI engine 108 can include several modules (e.g., hardware and/or software) such as a machine learning (ML) module, a natural language processing (NLP) module, and a knowledge representation and reasoning module. NLP is the ability of a computer program to understand human language as it is spoken and written -- referred to as natural language. The goal is a computer capable of “understanding” the contents of utterances or documents, including the contextual nuances of the language within them. The technology can then accurately extract information and insights contained therein as well as categorize and organize the inputs themselves. Related technologies include speech recognition, natural language understanding, and natural language generation.

Knowledge representation and reasoning relates to representing information about the world in a form that a computer system can utilize to solve complex tasks such as having a dialog in a natural language. Knowledge representation incorporates findings from psychology about how humans solve problems and represents knowledge in order to design formalisms that will make complex systems easier to design and build. Knowledge representation and reasoning also incorporates findings from logic to automate various kinds of reasoning, such as the application of rules or the relations of sets and subsets. Examples of knowledge representation formalisms include semantic nets, systems architecture, frames, rules, and ontologies. Examples of automated reasoning engines include inference engines, theorem provers, and classifiers. Various additional AI techniques and details are described in relation to FIGS. 5 and 6 below. Other techniques and details that are well known to persons skilled in the art are omitted for the sake of brevity.

Since the AI engine 108 can include various AI/ML modules, as described above, the AI engine 108 can be or can include an AI agent. An AI agent is a software component that executes an AI model or algorithm, applies the model to a dataset, and processes the output of the model to automatically perform one or more functions. For example, an AI agent 316 can invoke a neural network, decision tree, or other ML algorithm trained to interpret natural language describing information about a product, apply this algorithm to the natural language and/or context data available to the AI agent, and then use the output of the algorithm to generate a product description based on the interpreted information.

The system 100 includes a manager node 112 that can mediate the flow of data from the electronic device 102 to other components of the system 100. In some embodiments, the manager node 112 can include any number of server computers communicatively coupled to the electronic device 102 via the network access nodes 106. The manager node 112 can include combinations of hardware and/or software to process data, perform functions, communicate over the network(s) 104, etc. For example, server computers of the manager node 112 can include a processor, memory or storage, a transceiver, a display, operating system and application software, and the like. Other components, hardware, and/or software included in the system 100 that are well known to persons skilled in the art are not shown or discussed herein for brevity. Moreover, although shown as being included in the network(s) 104, the manager node 112 can be located anywhere in the system 100 to implement the disclosed technology.

The system 100 includes a search engine 110 that can process queries to identify data related to product descriptions used to populate a template for creating effective product descriptions. The search engine 110 is a software system that is designed to carry out web searches. It can search the World Wide Web in a systematic way for particular information specified in a search query. The search results can include a mix of links to web pages, images, videos, infographics, articles, research papers, datasheets, and other types of files. In one example, the search engine 110 mines data available in databases or open directories. Unlike web directories, which are maintained only by human editors, search engines also maintain real-time information by running an algorithm on a web crawler.

The manager node 112 can receive raw data from the electronic device 102. The raw data can include a description of a product. The manager node 112 can generate a search query based on the raw data and use the search engine 110 to search the internet for product description data that satisfy the query. The manager node 112 can then parse the product descriptions into categories of content that map to sections of a template and creating the custom product description based on a selection and combination of the categories of content of the product descriptions matched to the sections of the template. An AI engine 108 is trained based on the selection and combination of the categories of content and ranks the content based on a frequency of being included in custom product descriptions such that the AI engine 108 can later recommend content in accordance with the ranking, for creating an optimal product description by using the template.

### PROCESS FOR AI ENGINE-ASSISTED CREATION OF PRODUCT DESCRIPTIONS

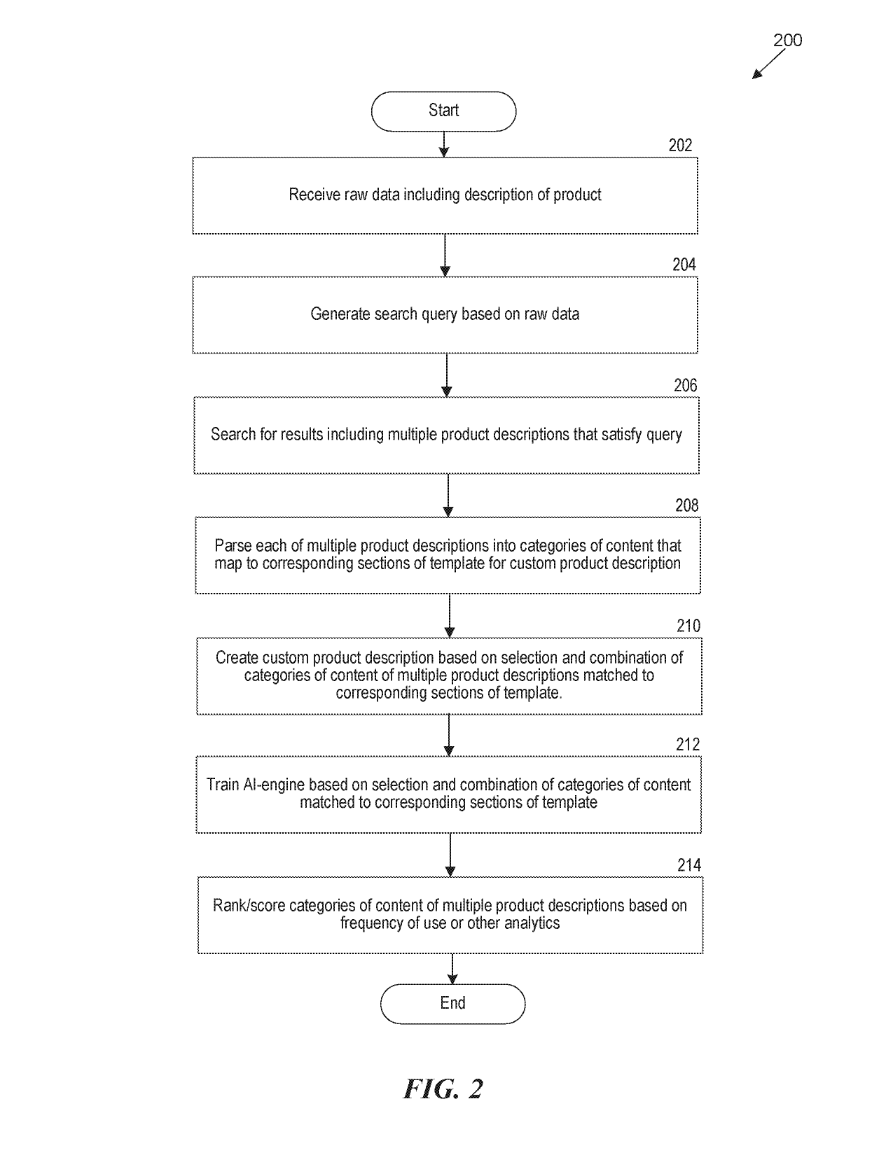

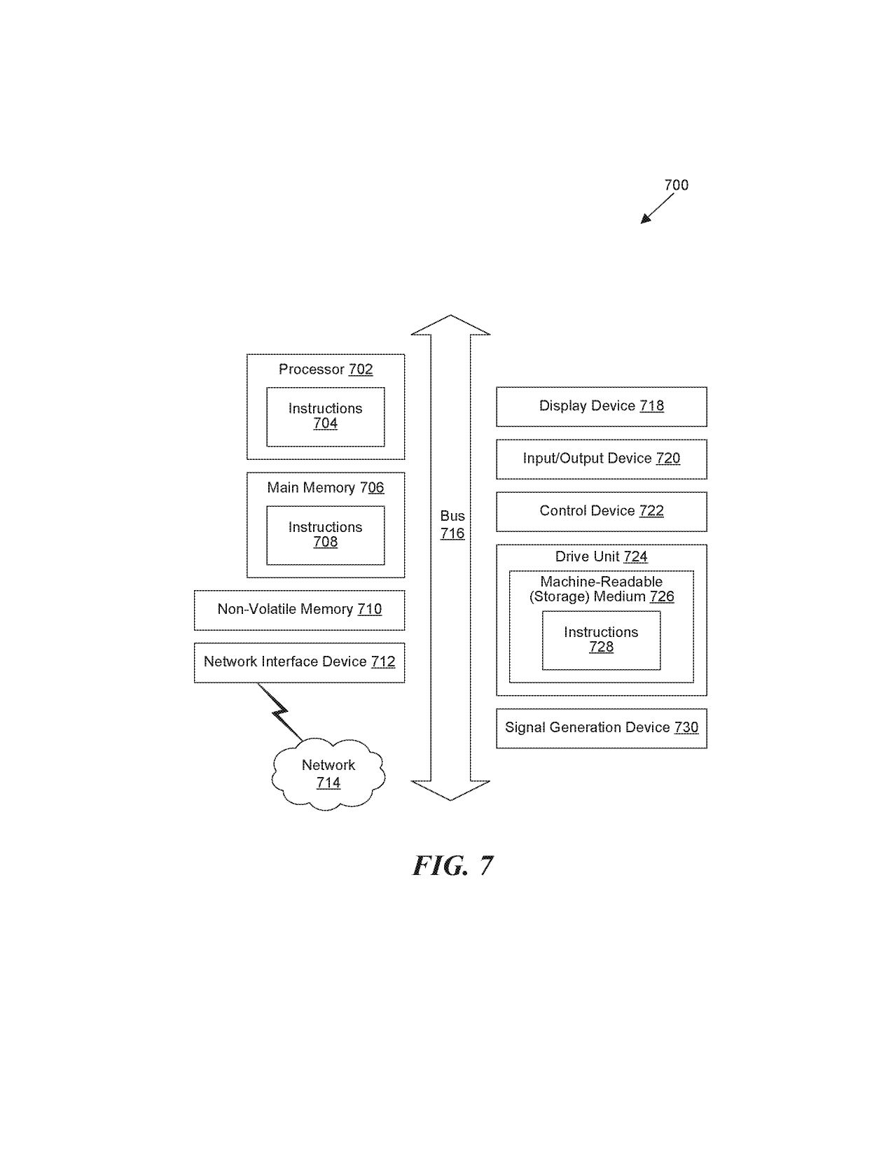

FIG. 2 is a flowchart that illustrates a process 200 for AI engine-assisted creation of product descriptions, in accordance with some implementations of the present technology. The process 200 can be performed by one or more components of a system including a manager node, AI engine, and/or search engine coupled to an electronic device, such as the system 100 described in relation to FIG. 1 above. In some implementations, the process 200 is performed by components of the example computer system illustrated and described in more detail in relation to FIG. 7 below. Likewise, implementations can include different and/or additional operations or can perform the operations in different orders.

At 202, the system receives raw data including descriptions of products. In one example, a customer sends a data file for a system that administers a platform configured to post descriptions of products on a website for resale. The data file can be a spreadsheet that lists an excess inventory including multiple products available for resale. The data file may include sparse information about the products including, for example, some product identifiers, manufacturer names, vendor identifiers, part numbers, and/or partial descriptions (e.g., provided by the original buyer/reseller/broker).

At 204, the system generates a search query by pre-processing the raw data. For example, the system can store a dictionary of keywords that are used to search the data file, sort, and organize the content of the data file to extract meaningful information. In one example, the system includes a model used to generate a probability that a product description in the data file corresponds to an identifiable product. The model can be trained using ML techniques to improve the accuracy with which it predicts the likelihood that a product is correctly identified. In one example, the model can perform NLP of the text included in the data file to look for commonalities and identify or predict a specific product based on generic or sparse data.

At 206, the system searches the internet for results including multiple product descriptions that satisfy the query. At 208, the system parses each of the multiple product descriptions into one or more categories of content that map to corresponding sections of a template for a custom product description. As such, the model can differentiate between multiple permutations of the same product to identify a specific version, etc.

At 210, the system creates the custom product description based on a selection and combination of the categories of content of the product descriptions matched to the corresponding sections of the template. In one example, the selection and combination of the categories of content of the product descriptions is based on user input.

The model (e.g., of the AI engine) can be trained based on data found online from posting of similar or the same products. For example, the system can include a search engine (or use a commercial search engine) to search for postings of similar or the same products. The search query can be based on a combination of the information extracted from data files received from clients. The search results are retrieved and stored as content for product descriptions. The content can include text, images, videos, etc. In one example, the system performs a form of scraping or utilizes a third-party service to perform the scraping for product descriptions.

The system parses each of the product descriptions retrieved from different sources into one or more categories of content that map to corresponding sections of the template for a custom product description. The categories of content can be mixed-and-matched to populate the template such that the system creates a custom product description based on the combination. The categories of content can include text, brands, logos, images, videos, pricing information, etc.

At 212, the system trains an AI engine based on the selection and combination of the categories of content of the multiple product descriptions matched to the corresponding sections of the template. The AI engine can alternatively or additionally be trained based on the raw data obtained from the buyer/reseller (e.g., from the data files). The input or output of the AI engine can be in JSON format, EXCEL format, etc.

At 214, the system can rank and/or score categories of content of the product descriptions based on, for example, a frequency of being included in multiple custom product descriptions or another metric or statistic. The rank/score can reflect the likelihood that a particular category of content is a good match for a custom product description.

The AI engine is configured to recommend the categories of content of the multiple product descriptions in accordance with the ranking for populating the template for the custom product description, which can be determine algorithmically or based on predefined criteria. In one example, the AI engine includes a model that predicts the likelihood of an accurate match of content for a customized product description based on a rating score (e.g., high, medium, low). The AI engine can disambiguate data that is processed using NLP score recommendations, based on a weighted model and/or decision tree. For example, sometimes there's a match with a part number that is actually a serial number because the buyer-reseller doesn't understand, and the model can disambiguate this level of complexity.

In one example, the system can receive user input including edits to the custom product description created based on the selection and combination of the categories of content of the multiple product descriptions. For example, the model would learn if users delete portions of content and later recommend the content without the portion. The system can train the AI engine based on the edits such that the AI engine is configured to recommend the categories of content of the multiple product descriptions in accordance with the ranking and modified in accordance with the edits for populating the template for the custom product description.

The custom product descriptions are rich with content that is more likely to draw the attention of potential buyers. Moreover, the content rich product descriptions may be more highly ranked as search results because they include combinations of keywords that are more commonly included in search queries for the products. Thus, search engines will rank custom product descriptions higher than manually created product descriptions. As such, the products associated with the custom product descriptions are more likely to sell compared to the same products but with product descriptions that are manually prepared by resellers.

### Processing System

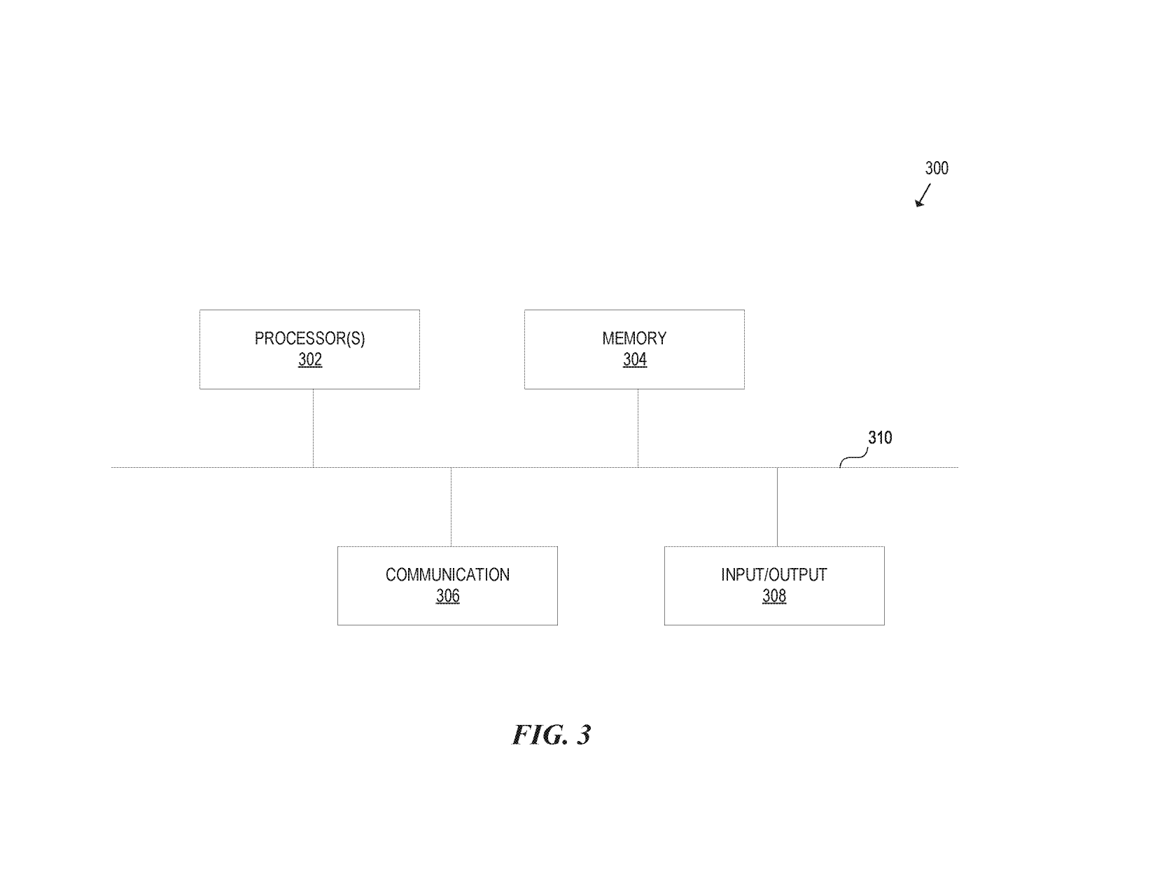

FIG. 3 is a block diagram that illustrates an example of a processing system 300 in which at least some operations described herein can be implemented. The processing system 300 represents a system that can run any of the methods/algorithms described herein. For example, any network access device (e.g., electronic device 102) or network component (access node 106-1 or manager node 112) can include or be part of a processing system 300. The processing system 300 can include one or more processing devices, which can be coupled to each other via a network or multiple networks. A network can be referred to as a communication network or telecommunications network.

In the illustrated embodiment, the processing system 300 includes one or more processors 302, memory 304, a communication device 306, and one or more input/output (I/O) devices 308, all coupled to each other through an interconnect 310. The interconnect 310 can be or include one or more conductive traces, buses, point-to-point connections, controllers, adapters and/or other conventional connection devices. Each of the processor(s) 302 can be or include, for example, one or more general-purpose programmable microprocessors or microprocessor cores, microcontrollers, application-specific integrated circuits (ASICs), programmable gate arrays, or the like, or a combination of such devices.

The processor(s) 302 control the overall operation of the processing system 300. Memory 304 can be or include one or more physical storage devices, which can be in the form of random-access memory (RAM), read-only memory (ROM) (which can be erasable and programmable), flash memory, miniature hard disk drive, or other suitable type of storage device, or a combination of such devices. Memory 304 can store data and instructions that configure the processor(s) 302 to execute operations in accordance with the techniques described above. The communication device 306 can be or include, for example, an Ethernet adapter, cable modem, Wi-Fi adapter, cellular transceiver, Bluetooth transceiver, or the like, or a combination thereof. Depending on the specific nature and purpose of the processing system 300, the I/O devices 308 can include devices such as a display (which can be a touch screen display), audio speaker, keyboard, mouse or other pointing devices, microphone, camera, etc.

While processes or blocks are presented in a given order, alternative embodiments can perform routines having steps or employ systems having blocks, in a different order, and some processes or blocks can be deleted, moved, added, subdivided, combined and/or modified to provide alternative or sub-combinations, or can be replicated (e.g., performed multiple times). Each of these processes or blocks can be implemented in a variety of different ways. In addition, while processes or blocks are at times shown as being performed in series, these processes or blocks can instead be performed in parallel or can be performed at different times. When a process or step is "based on" a value or a computation, the process or step should be interpreted as based at least on that value or that computation.

Software or firmware to implement the techniques introduced here can be stored on a machine-readable storage medium and can be executed by one or more general-purpose or special-purpose programmable microprocessors. A "machine-readable medium", as the term is used herein, includes any mechanism that can store information in a form accessible by a machine (a machine can be, for example, a computer, network device, cellular phone, personal digital assistant (PDA), manufacturing tool, any device with one or more processors, etc.). For example, a machine-accessible medium includes recordable/non-recordable media (e.g., read-only memory (ROM), random-access memory (RAM), magnetic disk storage media, optical storage media, flash memory devices), etc.

Note that any and all of the embodiments described above can be combined with each other, except to the extent that it may be stated otherwise above, or to the extent that any such embodiments might be mutually exclusive in function and/or structure. Although the present invention has been described with reference to specific exemplary embodiments, it will be recognized that the invention is not limited to the embodiments described but can be practiced with modification and alteration within the spirit and scope of the disclosed embodiments. Accordingly, the specification and drawings are to be regarded in an illustrative sense rather than a restrictive sense.

Physical and functional components (e.g., devices, engines, modules, and data repositories) associated with processing system 300 can be implemented as circuitry, firmware, software, other executable instructions, or any combination thereof. For example, the functional components can be implemented in the form of special-purpose circuitry, in the form of one or more appropriately programmed processors, a single board chip, a field-programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip. The tangible storage memory can be computer-readable data storage. The tangible storage memory can be a volatile or non-volatile memory. In some embodiments, the volatile memory can be considered "non-transitory" in the sense that it is not a transitory signal. Memory space and storage described in the figures can be implemented with the tangible storage memory as well, including volatile or non-volatile memory.

Each of the functional components can operate individually and independently of other functional components. Some or all of the functional components can be executed on the same host device or on separate devices. The separate devices can be coupled through one or more communication channels (e.g., wireless or wired channel) to coordinate their operations. Some or all of the functional components can be combined as one component. A single functional component can be divided into sub-components, each sub-component performing separate method steps or a method step of the single component.

In some embodiments, at least some of the functional components share access to a memory space. For example, one functional component can access data accessed by or transformed by another functional component. The functional components can be considered "coupled" to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implement a portion of the functional components). Other arrays, systems, and devices described above can include additional, fewer, or different functional components for various applications.

Aspects of the disclosed embodiments may be described in terms of algorithms and symbolic representations of operations on data bits stored in memory. These algorithmic descriptions and symbolic representations generally include a sequence of operations leading to the desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

### Process for AI Agent Training

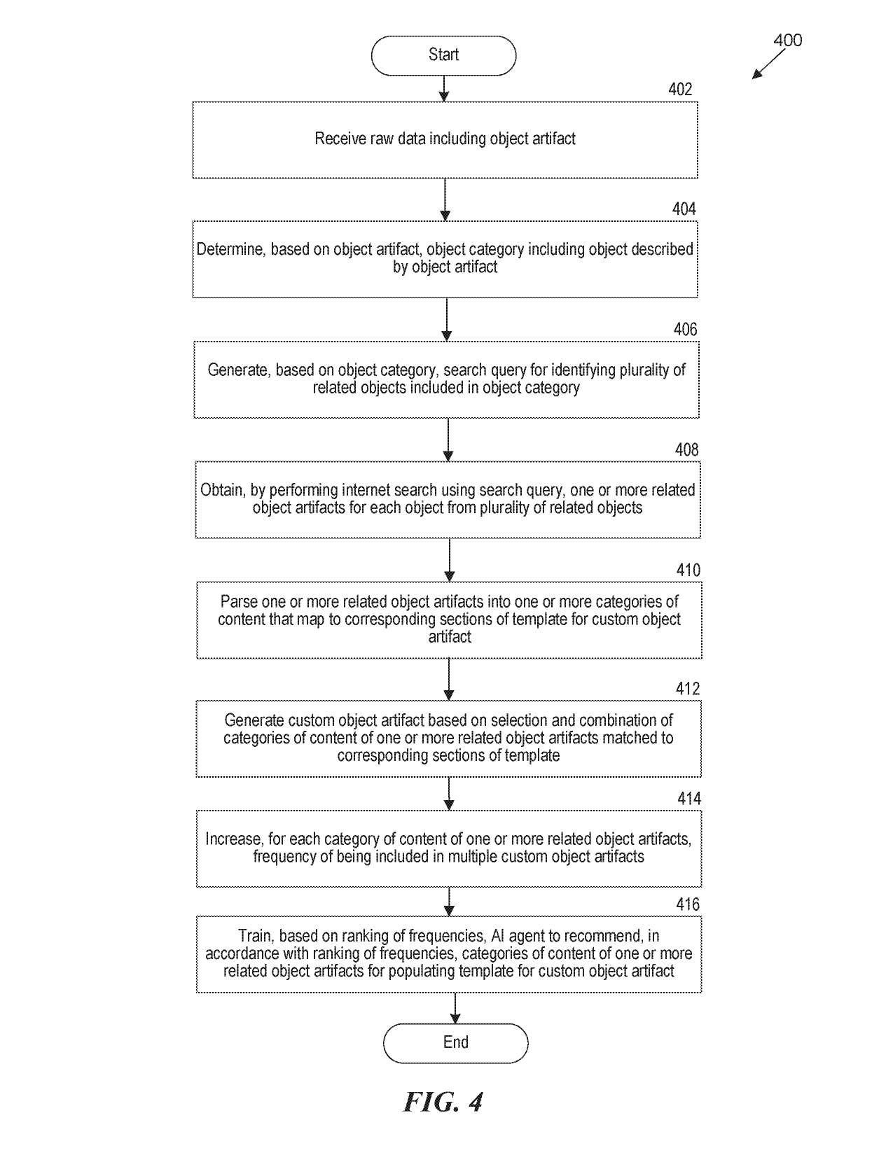

FIG. 4 is a flowchart that illustrates a process 400 for training an AI agent to assist in the creation of a custom object artifact, in accordance with some implementations of the present technology. In some implementations, the process 400 is performed by components of the example computer system illustrated and described in more detail in relation to FIG. 7 below and/or the system 100 illustrated and described in more detail in relation to FIG. 1 above. Likewise, implementations can include different and/or additional operations or can perform the operations in different orders.

At 402, raw data including an object artifact is received. Generally speaking, an artifact is an object or unit of data created by a data processing or collecting activity. An object artifact is an artifact describing one or more physical objects, thereby enabling information about those physical objects to be digitally recorded. For example, an object artifact can be a description of a product that is included in a data file received as the raw data, as described in relation to operation 202 of FIG. 2 above. In some implementations, the object artifact is generated by a current owner of an object (e.g., an individual or entity that possesses and/or has legal title to the object) to describe the object.

At 404, a determination is made, based on the object artifact, of an object category including the object described by the object artifact. An object category is a grouping of similar objects that share certain identifiable characteristics, such as a product category (e.g., “watches,” “radios,” etc.). In some implementations, the determination is made by using a model to generate a probability that the object artifact describes a product belonging to an identifiable product category, as described in relation to the product identification of operation 204 of FIG. 2 above. In such implementations, the model can be invoked and/or the determination can be generated automatically by an AI agent, such as the AI engine 108 described in relation to FIG. 1 above. In these and other implementations, the object category can be a single product or part having a specific version (e.g.,” iPhone17 Pro,” rather than just an “iPhone”), as identified by a manufactured part number (MFN), a stock-keeping unit (SKU), and/or another unique identifier of a product.

At 406, based on the object category, a search query is generated for identifying a plurality of related objects included in the object category. For example, the search query can be generated based on commonalities between descriptions of objects in the object category, as described in relation to the product descriptions of operation 204 of FIG. 2 above. As another example, the search query can include a unique identifier for the object category, where the object category is a single product or part as described above. In some implementations, a second AI agent is provided, as input, at least one of (1) the object artifact or (2) the object category and generates, as output, the search query (e.g., by invoking a model to identify the commonalities described above). The plurality of related objects are objects related to the object described in the artifact by virtue of being included in the same object category. Generating the search query based on the object category can improve the accuracy of the search query for identifying objects that are included in the object category, as the search query is more likely to contain information (e.g., keywords, phrase) that accurately identify objects of that category.

At 408, by performing an internet search using the search query, one or more related object artifacts for each object from the plurality of related objects are obtained. Each of the related object artifacts is an artifact describing the corresponding related object, such as a product description for that related object. The related object artifacts can be obtained from different locations on the internet (e.g., different webpages, databases, etc.), which can result in a collection of related object artifacts that are broadly representative of artifacts describing objects in the object category.

At 410, the one or more related object artifacts are parsed into one or more categories of content that map to corresponding sections of a template for a custom object artifact. For example, the parsing can be performed using a third AI agent that includes a model for parsing text, audio, and/or images included and that sorts the one or more related object artifacts into the one or more categories of content based on features of those artifacts (e.g., format, semantic content, length). The third AI agent can determine, using the model, a likelihood of each of the one or more related object artifacts describing the exact object and only parse those related object artifacts having a high likelihood (e.g., > 50%) into the one or more categories of content, thereby improving the quality of the template for representing the object accurately. For example, in implementations where the object is a product for sale, the template can include sections for a text description, a product title, a price, an image of the object, and/or other categories of content relevant to sale of the object, and the one or more related object artifacts can be parsed into each of these categories of content based on the category which most closely describes that artifact.

At 412, the custom object artifact is generated based on a selection and combination of the categories of content of the one or more related object artifacts matched to the corresponding sections of the template. The custom object artifact can be a new description of the object that is generated to include information belonging to each selected category of the categories of content, such as a product description/product listing that can appear on an e-commerce website. For example, the selection and combination of the categories of content of the one or more related object artifacts can be provided to a fourth AI agent that generates, as output, the custom object artifact. In some implementations, the fourth AI agent can process the one or more related object artifacts matched to each selected category to generate a new artifact in each selected category that is based on those artifacts, enabling various components of the custom object artifact (e.g., a product title, a product image, a text description) to be based on artifacts having similar features rather than a more general collection of artifacts, which can improve the relevance and descriptive accuracy of the custom object artifact overall. In these and other implementations, the selection and combination of the categories of content of the one or more related object artifacts is based on user input, with the user being an individual or entity. For example, the user can be the current owner of the object, who selects the categories of content in order to cause generation of a product description/product listing for the object.

In some implementations, display can be caused (e.g., via the network(s) 104 described in relation to FIG. 1 above) of the custom object artifact on a public website. For example, where the custom object artifact is a product description, the public website can be an e-commerce website such as amazon.com or ebay.com where members of the public can view the product description and potentially purchase the object. A request associated with the custom object artifact (e.g., a purchase notification, a request for a quote) can then be received via the public website and a notification indicating the request was received can be transmitted to the current owner of the object. Thus, the process 400 can automatically post the custom object artifact to a public website and notify the current owner of the object when a request related to the object is received, enabling the current owner to respond accordingly without having to manually generate the custom object artifact or interact with the public website. For example, where the request is a purchase notification, the notification can signal, to the current owner, that another individual or entity wishes to purchase the object, enabling the current owner to transfer ownership of the object accordingly.

At 414, a frequency of being included in multiple custom object artifacts is increased for each category of content of the one or more related object artifacts. The frequency counts a number of times each category is included in custom object artifacts that have been generated and thereby reflects the likelihood that a particular category of content is a good match for a custom object artifact/is more desirable to include in a custom object artifact. In some implementations, the frequency for each category of content is included in a ranking of frequencies, which is a data structure including each frequency such that the relative frequencies for inclusion in multiple custom object artifacts of the categories of content are comparable.

At 416, an AI agent is trained, based on a ranking of frequencies, to recommend, in accordance with the ranking of frequencies, the categories of content of the one or more related object artifacts for populating the template for the custom object artifact. In some implementations, the AI agent is, or is included in, the AI engine described in relation to FIGS. 1 and 2 above and recommends categories in a generally same or similar manner. Training the AI agent based on the ranking of frequencies can improve the accuracy with which the AI agent can recommend the inclusion of relevant categories of content in custom object artifacts. For example, where categories of content are selected by users to generate product descriptions, the AI agent can be trained over time to recommend categories of content that users are more likely to desire for inclusion in a product listing. Furthermore, training the AI agent based on the ranking of frequencies instead of another metric that does not rely on user input reduces the likelihood that the AI agent will improperly recommend the inclusion of content in a custom object artifact that does not correspond to that object (e.g., described a different product) and/or is otherwise information that users do not desire for inclusion in custom object artifacts. The AI agent thereby becomes more responsive to user preferences over time, leading to more rapid generation of custom object artifacts that are responsive to user preferences. In some implementations, after sufficient training, the AI agent can be directed to select categories of content for populating the template independently of user input, enabling automatic artifact generation while also maintaining a high probability that those artifacts conform to user standards.

In some implementations, the AI agent and/or another AI can also be trained, based on the ranking of frequencies, to identify particular sources from which to obtain the one or more related object artifacts. For example, where the ranking of frequencies indicates that categories of content are included in custom object artifacts more often when those categories include related object artifacts from a particular source (e.g., a particular website, a particular database of information about products), the AI agent can learn to prioritize obtaining related object artifacts from that particular source when generating future search queries. Thus, over time, a greater percentage of the related object artifacts that are obtained and parsed into the one or more categories of content can come from sources which are most likely to result in custom object artifacts that are desirable to users, improving the ability of the template to provide relevant information and streamline the artifact generation process.

In some implementations, user input is received including an edit to the custom object artifact. Such an edit can be a deletion to or a modification of a particular portion of the custom object artifact corresponding to a particular category of content. Thus, the edit can indicate that a user was not satisfied with the inclusion of the particular category of content in the custom object artifact, as described in relation to FIG. 2 above. Accordingly, the ranking of frequencies can be modified based on the edit (e.g., the frequency for the particular category of content can be reduced), thereby reflecting that the user effectively recanted the initial selection of one or more categories of content. The AI agent can then be re-trained, based on the modified ranking of frequencies, to recommend, in accordance with the modified ranking of frequencies, the categories of content of the one or more related object artifacts for populating the template for the custom object artifact. Thus, the AI agent can be trained to reflect a latest ranking of frequencies and continually be adapted to additional information received from users via edits.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term “DNN” may encompass any neural network having multiple layers, including graph neural networks (GNNs), convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), may represent a subject domain (e.g., scientific papers), and/or may encompass another domain or domains, be they larger or smaller than a single language or subject domain. For example, a relatively large, multilingual, and non-subject-specific corpus may be created by extracting text from online web pages and/or publicly available social media posts. Training data may be annotated with ground truth labels (e.g., each data entry in the training dataset may be paired with a label) or may be unlabeled.

As another example, to train an ML model that is intended to generate images, the training dataset may be a dataset of image-text pairs. The dataset represents a text domain (e.g., a caption corresponding to the image), a language domain (e.g., the language the caption is written in), and/or encompasses another domain or domains, be they larger or smaller than a single text or language domain. For example, a relatively large and non-subject-specific dataset may be created by extracting images from online web pages and/or publicly available social media posts and associating text captions with those images.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder) or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger dataset. For example, a dataset may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger dataset and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models may also be used for chatbots (e.g., virtual assistance).

Additionally or alternatively, language models may be embedded into other ML models, such as a diffusion model (e.g., Stable Diffusion, Dall-E, Midjourney) that are trained to generate images based on processing of a natural language input performed by the language model. For example, the language model may process the natural language input into a guidance vector containing information regarding the type of image to be generated. The diffusion model may then receive an input tensor, which is typically an image of randomly generated noise. Through a process of denoising, noise is gradually removed from the input tensor in a manner specified by the guidance vector. The denoising process continues until the resulting image resembles the type of image specified by the natural language input. The diffusion model may then provide the resulting image as output.

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. Although transformer-based language models are described herein, it should be understood that the present disclosure may be applicable to any ML-based model, including language models based on other neural network architectures such as recurrent neural network (RNN)-based language models.

FIG. 5 is a block diagram 500 of an example transformer 512, in accordance with some implementations of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence.

The transformer 512 includes an encoder 508 (which can comprise one or more encoder layers/blocks connected in series) and a decoder 510 (which can comprise one or more decoder layers/blocks connected in series). Generally, the encoder 508 and the decoder 510 each include a plurality of neural network layers, at least one of which can be a self-attention layer. The parameters of the neural network layers can be referred to as the parameters of the language model.

The transformer 512 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user’s writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 512 is trained to perform certain functions on other input formats than natural language input. For example, the input can include objects, images, audio content, or video content, or a combination thereof.

The transformer 512 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input, generating images based on natural language inputs). FIG. 5 illustrates an example of how the transformer 512 can process textual input data. Input to a language model (whether transformer-based or otherwise) typically is in the form of natural language that can be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 5, a short sequence of tokens 502 corresponding to the input text is illustrated as input to the transformer 512. Tokenization of the text sequence into the tokens 502 can be performed by some pre-processing tokenization module such as, for example, a byte-pair encoding tokenizer (the “pre” referring to the tokenization occurring prior to the processing of the tokenized input by the LLM), which is not shown in FIG. 5 for simplicity. In general, the token sequence that is inputted to the transformer 512 can be of any length up to a maximum length defined based on the dimensions of the transformer 512. Each token 502 in the token sequence is converted into an embedding vector 506 (also referred to simply as an embedding 506). An embedding 506 is a learned numerical representation (such as, for example, a vector) of a token that captures some semantic meaning of the text segment represented by the token 502. The embedding 506 represents the text segment corresponding to the token 502 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 506 corresponding to the “write” token will be closer to another embedding corresponding to the “jot down” token in the vector space as compared to the distance between the embedding 506 corresponding to the “write” token and another embedding corresponding to the “summary” token.

The vector space can be defined by the dimensions and values of the embedding vectors. Various techniques can be used to convert a token 502 to an embedding 506. For example, another trained ML model can be used to convert the token 502 into an embedding 506. In particular, another trained ML model can be used to convert the token 502 into an embedding 506 in a way that encodes additional information into the embedding 506 (e.g., a trained ML model can encode positional information about the position of the token 502 in the text sequence into the embedding 506). In some examples, the numerical value of the token 502 can be used to look up the corresponding embedding in an embedding matrix 504 (which can be learned during training of the transformer 512).

The generated embeddings 506 are input into the encoder 508. The encoder 508 serves to encode the embeddings 506 into feature vectors 514 that represent the latent features of the embeddings 506. The encoder 508 can encode positional information (i.e., information about the sequence of the input) in the feature vectors 514. The feature vectors 514 can have very high dimensionality (e.g., on the order of thousands or tens of thousands), with each element in a feature vector 514 corresponding to a respective feature. The numerical weight of each element in a feature vector 514 represents the importance of the corresponding feature. The space of all possible feature vectors 514 that can be generated by the encoder 508 can be referred to as the latent space or feature space.

Conceptually, the decoder 510 is designed to map the features represented by the feature vectors 514 into meaningful output, which can depend on the task that was assigned to the transformer 512. For example, if the transformer 512 is used for a translation task, the decoder 510 can map the feature vectors 514 into text output in a target language different from the language of the original tokens 502. Generally, in a generative language model, the decoder 510 serves to decode the feature vectors 514 into a sequence of tokens. The decoder 510 can generate output tokens 516 one by one. Each output token 516 can be fed back as input to the decoder 510 in order to generate the next output token 516. By feeding back the generated output and applying self-attention, the decoder 510 is able to generate a sequence of output tokens 516 that has sequential meaning (e.g., the resulting output text sequence is understandable as a sentence and obeys grammatical rules). The decoder 510 can generate output tokens 516 until a special [EOT] token (indicating the end of the text) is generated. The resulting sequence of output tokens 516 can then be converted to a text sequence in post-processing. For example, each output token 516 can be an integer number that corresponds to a vocabulary index. By looking up the text segment using the vocabulary index, the text segment corresponding to each output token 516 can be retrieved, the text segments can be concatenated together, and the final output text sequence can be obtained.

In some examples, the input provided to the transformer 512 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an application programming interface (API)). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Artificial Intelligence System

FIG. 6 is a block diagram that illustrates an example of an AI system 600 in which at least some operations described herein can be implemented. Example ML models can include one or models executed by the AI engine 108 described in relation to FIG. 1. Accordingly, the AI engine 108 can include one or more components of the AI system 600.

As shown in FIG. 6, the AI system 600 can include a set of layers, which conceptually organize elements within an example network topology for the AI system’s architecture to implement a particular AI model 630. Generally, an AI model 630 is a computer-executable program implemented by the AI system 600 that analyzes data to make predictions. Information can pass through each layer of the AI system 600 to generate outputs for the AI model 630. The layers can include a data layer 602, a structure layer 604, a model layer 606, and an application layer 608. The algorithm 616 of the structure layer 604 and the model structure 620 and model parameters 622 of the model layer 606 together form the example AI model 630. The optimizer 626, loss function engine 624, and regularization engine 628 work to refine and optimize the AI model 630, and the data layer 602 provides resources and support for application of the AI model 630 by the application layer 608.

The data layer 602 acts as the foundation of the AI system 600 by preparing data for the AI model 630. As shown, the data layer 602 can include two sub-layers: a hardware platform 610 and one or more software libraries 612. The hardware platform 610 can be designed to perform operations for the AI model 630 and include computing resources for storage, memory, logic, and networking. The hardware platform 610 can process amounts of data using one or more servers. The servers can perform backend operations such as matrix calculations, parallel calculations, ML training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 610 can include Infrastructure as a Service (IaaS) resources, which are computing resources (e.g., servers, memory, etc.) offered by a cloud services provider. The hardware platform 610 can also include computer memory for storing data about the AI model 630, application of the AI model 630, and training data for the AI model 630. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages such that servers of the hardware platform 610 can use the low-level primitives to carry out specific operations. The low-level programming languages do not require much, if any, abstraction from a computing resource’s instruction set architecture, allowing them to run quickly with a small memory footprint. Examples of software libraries 612 that can be included in the AI system 600 include Intel Math Kernel Library, Nvidia cuDNN, Eigen, and OpenBLAS.

The structure layer 604 can include an ML framework 614 and an algorithm 616. The ML framework 614 can be thought of as an interface, library, or tool that allows users to build and deploy the AI model 630. The ML framework 614 can include an open-source library, an API, a gradient-boosting library, an ensemble method, and/or a deep learning toolkit that work with the layers of the AI system to facilitate development of the AI model 630. For example, the ML framework 614 can distribute processes for application or training of the AI model 630 across multiple resources in the hardware platform 610. The ML framework 614 can also include a set of pre-built components that have the functionality to implement and train the AI model 630 and allow users to use pre-built functions and classes to construct and train the AI model 630. Thus, the ML framework 614 can be used to facilitate data engineering, development, hyperparameter tuning, testing, and training for the AI model 630. Examples of ML frameworks 614 that can be used in the AI system 600 include TensorFlow, PyTorch, Scikit-Learn, Keras, Caffe, LightGBM, Random Forest, and Amazon Web Services.

The algorithm 616 can be an organized set of computer-executable operations used to generate output data from a set of input data and can be described using pseudocode. The algorithm 616 can include complex code that allows the computing resources to learn from new input data and create new/modified outputs based on what was learned. In some implementations, the algorithm 616 can build the AI model 630 through being trained while running computing resources of the hardware platform 610. This training allows the algorithm 616 to make predictions or decisions without being explicitly programmed to do so. Once trained, the algorithm 616 can run at the computing resources as part of the AI model 630 to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include asset tracking histories with known threat levels, resources with known relevancy scores measuring their relevance to known assets, and logs of physical and digital features with known correspondences and similarities. The user may label the training data based on one or more classes and train the AI model 630 by inputting the training data to the algorithm 616. The algorithm determines how to label the new data based on the labeled training data. The user can facilitate collection, labeling, and/or input via the ML framework 614. In some instances, the user may convert the training data to a set of feature vectors for input to the algorithm 616. Once trained, the user can test the algorithm 616 on new data to determine if the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can involve classification and/or regression. Classification techniques involve teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data (e.g., service name, asset room location, asset internet protocol (IP) address) relate to the categories (e.g., high risk or low risk of cybersecurity attack). Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for ML-based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Said another way, unsupervised learning is used to train the algorithm 616 to find an underlying structure of a set of data, group the data according to similarities, and represent that set of data in a compressed format. In some implementations, performance of the algorithm 616 that can use unsupervised learning is improved because it can learn how to fine-tune the model by setting an ideal cutoff score for relevancy rank, as described herein.

A few techniques can be used in unsupervised learning: clustering, anomaly detection, and techniques for learning latent variable models. Clustering techniques involve grouping data into different clusters that include similar data such that other clusters contain dissimilar data. For example, during clustering, data with possible similarities remain in a group that has less or no similarities to another group. Examples of clustering techniques include density-based methods, hierarchical-based methods, partitioning methods, and grid-based methods. In one example, the algorithm 616 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 may be trained to be an Isolation Forest, local outlier factor (LOF) algorithm, or k-NN algorithm. Latent variable techniques involve relating observable variables to a set of latent variables. These techniques assume that the observable variables are the result of an individual’s position on the latent variables and that the observable variables have nothing in common after controlling for the latent variables. Examples of latent variable techniques that may be used by the algorithm 616 include factor analysis, item response theory, latent profile analysis, and latent class analysis.

The model layer 606 implements the AI model 630 using data from the data layer 602 and the algorithm 616 and ML framework 614 from the structure layer 604, thus enabling decision-making capabilities of the AI system 600. The model layer 606 includes a model structure 620, model parameters 622, a loss function engine 624, an optimizer 626, and a regularization engine 628.

The model structure 620 describes the architecture of the AI model 630 of the AI system 600. The model structure 620 defines the complexity of the pattern/relationship that the AI model 630 expresses. Examples of structures that can be used as the model structure 620 include decision trees, support vector machines, regression analyses, Bayesian networks, Gaussian processes, genetic algorithms, and neural networks. The model structure 620 can include a number of structure layers, a number of nodes (or neurons) at each structure layer, and activation functions of each node. Each node’s activation function defines how the node converts data received to data output. The structure layers may include an input layer of nodes that receive input data and an output layer of nodes that produce output data. The model structure 620 may include one or more hidden layers of nodes between the input and output layers. The model structure 620 can be a neural network that connects the nodes in the structured layers such that the nodes are interconnected. Examples of neural networks include a transformer (e.g., the transformer 512, as described in relation to FIG. 5 above) or another neural network described above.

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model’s 630 performance during training. For instance, the loss function engine 624 can measure the difference between a predicted output of the AI model 630 and the actual output of the AI model 630 and is used to guide optimization of the AI model 630 during training to minimize the loss function. The loss function may be presented via the ML framework 614 such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model 630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF), and Limited-memory BFGS (L-BFGS). The type of optimizer 626 used may be determined based on the type of model structure 620 and the size of data and the computing resources available in the data layer 602.

The regularization engine 628 executes regularization operations. Regularization is a technique that prevents overfitting and underfitting of the AI model 630. Overfitting occurs when the algorithm 616 is overly complex and too adapted to the training data, which can result in poor performance of the AI model 630. Underfitting occurs when the algorithm 616 is unable to recognize even basic patterns from the training data such that it cannot perform well on training data or on validation data. The regularization engine 628 can apply one or more regularization techniques to fit the algorithm 616 to the training data properly, which helps constrain the resulting AI model 630 and improves its ability for generalized application. Examples of regularization techniques include lasso (L1) regularization, ridge (L2) regularization, and elastic (L1 and L2) regularization.

The application layer 608 describes how the AI system 600 is used to solve problems or perform tasks. In an example implementation, the application layer 608 can include the AI engine 108 and/or another component of the system 100 described in relation to FIG. 1 above.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an I/O device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), augmented reality (AR)/virtual reality (VR) systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer (SBC) system, or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable (storage) medium 726) can be local, remote, or distributed. Although shown as a single medium, the machine-readable (storage) medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable (storage) medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for training an artificial intelligence (AI) engine to assist in creation of object artifacts, the method comprising:
receiving raw data including an object artifact,
wherein the object artifact is generated by a current owner of an object to describe the object;
determining, based on the object artifact, an object category including the object;
generating, based on the object category, a search query for identifying a plurality of related objects included in the object category;
obtaining, by performing an internet search using the search query, one or more related object artifacts for each object from the plurality of related objects;
parsing the one or more related object artifacts into one or more categories of content that map to corresponding sections of a template for a custom object artifact;
generating the custom object artifact based on a selection and combination of the categories of content of the one or more related object artifacts matched to the corresponding sections of the template;
increasing, for each category of content of the one or more related object artifacts, a frequency of being included in multiple custom object artifacts,
wherein the frequency is included in a ranking of frequencies; and
training, based on the ranking of frequencies, a first artificial intelligence (AI) agent to recommend, in accordance with the ranking of frequencies, the categories of content of the one or more related object artifacts for populating the template for the custom object artifact.

2. The method of claim 1, further comprising:
providing, as input, at least one of (1) the object artifact or (2) the object category to a second AI agent that generates, as output, the search query; and
parsing the one or more related object artifacts into the one or more categories of content using a third AI agent.

3. The method of claim 1, further comprising:
providing, as input, the selection and combination of the categories of content of the one or more related object artifacts to a second AI agent that generates, as output, the custom object artifact.

4. The method of claim 3, further comprising:
causing display of the custom object artifact on a public website,
wherein the public website is selected based on the object category;
receiving, via the public website, a request associated with the custom object artifact; and
transmitting, to the current owner of the object, a notification indicating the request was received.

5. The method of claim 1, further comprising:
receiving user input including an edit to the custom object artifact;
modifying, based on the edit, the ranking of frequencies; and
re-training, based on the modified ranking of frequencies, the first AI agent to recommend, in accordance with the modified ranking of frequencies, the categories of content of the one or more related object artifacts for populating the template for the custom object artifact.

6. The method of claim 1, wherein the selection and combination of the categories of content of the one or more related object artifacts is based on user input.

7. One or more non-transitory, computer-readable storage media comprising instructions recorded thereon, wherein the instructions, when executed by at least one data processor of a system, cause the system to:
receive raw data including an object artifact,
wherein the object artifact is generated by a current owner of an object to describe the object;
determine, based on the object artifact, an object category including the object;
generate, based on the object category, a search query for identifying a plurality of related objects included in the object category;
obtain, by performing an internet search using the search query, one or more related object artifacts for each object from the plurality of related objects;
parse the one or more related object artifacts into one or more categories of content that map to corresponding sections of a template for a custom object artifact;
generate the custom object artifact based on a selection and combination of the categories of content of the one or more related object artifacts matched to the corresponding sections of the template;
in response to generation of the custom object artifact, automatically cause display of the custom object artifact on a public website,
wherein the public website is selected based on the object category;
receive, via the public website, a request associated with the custom object artifact; and
transmit, to the current owner of the object, a notification indicating the request was received.

8. The one or more non-transitory, computer-readable storage media of claim 7, further comprising instructions causing the system to:
provide, as input, at least one of (1) the object artifact or (2) the object category to a first AI agent that generates, as output, the search query; and
parse the one or more related object artifacts into the one or more categories of content using a second AI agent.

9. The one or more non-transitory, computer-readable storage media of claim 7, further comprising instructions causing the system to:
provide, as input, the selection and combination of the categories of content of the one or more related object artifacts to an AI agent that generates, as output, the custom object artifact.

10. The one or more non-transitory, computer-readable storage media of claim 7, further comprising instructions causing the system to:
increase, for each category of content of the one or more related object artifacts, a frequency of being included in multiple custom object artifacts,
wherein the frequency is included in a ranking of frequencies; and
train, based on the ranking of frequencies, an AI agent to recommend, in accordance with the ranking of frequencies, the categories of content of the one or more related object artifacts for populating the template for the custom object artifact.

11. The one or more non-transitory, computer-readable storage media of claim 10, further comprising instructions causing the system to:
receive user input including an edit to the custom object artifact;
modify, based on the edit, the ranking of frequencies; and
re-train, based on the modified ranking of frequencies, the AI agent to recommend, in accordance with the modified ranking of frequencies, the categories of content of the one or more related object artifacts for populating the template for the custom object artifact.

12. The one or more non-transitory, computer-readable storage media of claim 7, wherein the selection and combination of the categories of content of the one or more related object artifacts is based on user input.

13. A system comprising:
at least one hardware processor; and
at least one non-transitory memory storing instructions, which, when executed by the at least one hardware processor, cause the system to:
receive raw data including an object artifact;
generate, based on the raw data, a search query;
obtain, by performing an internet search using the search query, one or more related object artifacts;
parse the one or more related object artifacts into one or more categories of content that map to corresponding sections of a template for a custom object artifact,
generate the custom object artifact based on a selection and combination of the categories of content of the one or more related object artifacts matched to the corresponding sections of the template;
increase, for each category of content of the one or more related object artifacts, a frequency of being included in multiple custom object artifacts,
wherein the frequency is included in a ranking of frequencies; and
train, based on the ranking of frequencies, a first AI agent to recommend, in accordance with the ranking of frequencies, the categories of content of the one or more related object artifacts for populating the template for the custom object artifact.

14. The system of claim 13, wherein the search query is further generated by:
determining, based on the object artifact, an object category including the object; and
configuring the search query, based on the object category, to identify a plurality of related objects included in the object category.

15. The system of claim 13, further comprising instructions causing the system to:
provide, as input, at least one of (1) the object artifact or (2) the object category to a second AI agent that generates, as output, the search query; and
parse the one or more related object artifacts into the one or more categories of content using a third AI agent.

16. The system of claim 13, further comprising instructions causing the system to:
provide, as input, the selection and combination of the categories of content of the one or more related object artifacts to a second AI agent that generates, as output, the custom object artifact.

17. The system of claim 13, wherein the object artifact is generated by a current owner of an object to describe the object.

18. The system of claim 17, further comprising instructions causing the system to:
cause display of the custom object artifact on a public website,
wherein the public website is selected based on the object category;
receive, via the public website, a request associated with the custom object artifact; and
transmit, to the current owner of the object, a notification indicating the request was received.

19. The system of claim 13, further comprising instructions causing the system to:
receive user input including an edit to the custom object artifact;
modify, based on the edit, the ranking of frequencies; and
re-train, based on the modified ranking of frequencies, the first AI agent to recommend, in accordance with the modified ranking of frequencies, the categories of content of the one or more related object artifacts for populating the template for the custom object artifact.

20. The system of claim 13, wherein the selection and combination of the categories of content of the one or more related object artifacts is based on user input.
